(19) United States
(12) Patent Application Publication
(10) Pub. No.: US 2025/0383938 A1
(43) Pub. Date: Dec. 18, 2025

(54) SYSTEMS AND METHODS FOR PROACTIVE WORKLOAD MANAGEMENT

(71) Applicant: Capital One Services, LLC, McLean, VA (US)

(72) Inventors: Igor A. TRUBIN, Alexandria, VA (US); Jigneshkumar SHAH, McLean, VA (US)

(73) Assignee: Capital One Services, LLC, McLean, VA (US)

(21) Appl. No.: 18/743,056

(22) Filed: Jun. 13, 2024

(51) Int. Cl. G06F 9/50; G06F 11/34

(52) U.S. Cl. CPC G06F 9/5083; G06F 9/5044; G06F 11/3428

(57) ABSTRACT

In some aspects, systems and methods are described herein for determining rightsizing adjustments to a cluster of cloud servers using a multi-dimensional operating ratio. The system collects usage data from a cloud server, comprising multiple dimensions of cloud computation usage. The system then processes the usage data using a cleansing process to generate processed usage data, wherein the cleansing process comprises outlier removal and seasonality adjustment. The system compares the processed usage data against a benchmark to generate a workload metric. The workload metric corresponds to values in the multiple dimensions of the cloud computation usage, indicating a distance from the expected usage data. Based on the workload metric and using a predictive model, generating expected capacity needs. Based on the expected capacity needs, determining a set of rightsizing changes, wherein the set of rightsizing changes comprises changes to capacities of the cloud server.

### SUMMARY

Methods and systems are described herein for novel uses and/or improvements to cloud computing-based applications. As one example, methods and systems are described herein for proactive workload management for a cluster of cloud servers (or serverless containers) using a multi-dimensional operating ratio.

Conventional systems for adjusting cloud server capacities do not use comprehensive multi-dimensional data, such as a multi-dimensional operating ratio. Conventional systems therefore lack a framework for producing and leveraging high-quality data for predicting capacity needs. In particular, conventional systems do not collect usage data across multiple aspects of cloud server usage (e.g., CPU capacity usage, memory usage, network traffic, etc.), process the data to perform outlier removal and seasonality adjustments, then project capacity needs of multiple servers across a cluster to identify proactive capacity adjustments or rightsizing adjustments.

By contrast, systems and methods described herein store and process multiple dimensions of usage data to generate a multidimensional operating ratio. This processed data is both more comprehensive and more reliable than conventionally generated usage data, being more nuanced in its conception of usage limits and more perceptive to seasonal patterns or abnormalities. Using the multidimensional operating ratio, the system computes a workload metric indicating the distance from the cloud servers from its maximum capacity based on current and expected usage. Based on the workload metric, the system determines expected capacity needs of the cloud servers in anticipation of future usage. By being proactive in anticipating cloud servers' needs, the system makes agile responses to satisfy computing needs for cloud computing. Based on the expected capacity needs, the system may determine appropriate modifications to the cloud servers to meet capacity needs. The above processes allow the system to more suitably tailor the right adjustments to cloud servers that are most likely to satisfy capacity requirements.

In some aspects, methods and systems are described herein comprising: collecting usage data from a cloud server, comprising multiple dimensions of cloud computation usage; processing the usage data using a cleansing process to generate processed usage data, wherein the cleansing process comprises outlier removal and seasonality adjustment, wherein outlier removal identifies and removes volatile usage instances, and wherein seasonality adjustment modifies expected usage; comparing the processed usage data against a benchmark to generate a workload metric, wherein the benchmark is a real-valued vector specifying expected usage data, and wherein the workload metric corresponds to values in the multiple dimensions of the cloud computation usage, indicating a distance from the expected usage data; based on the workload metric and using a predictive model, generating expected capacity needs, wherein the expected capacity needs indicate cloud computing usage at a future point in time; based on the expected capacity needs, determining a set of capacity adjustment changes, wherein the set of capacity adjustment changes comprises changes to capacities of the cloud server; and based on the set of capacity adjustment changes, modifying the cloud server.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for determining rightsizing adjustments to a cluster of cloud servers using a multi-dimensional operating ratio, in accordance with one or more embodiments.

FIG. 2A shows unprocessed usage data collected from a cluster of cloud servers, in accordance with one or more embodiments.

FIG. 2B shows a prediction for an aspect of the operating ratio hitting a threshold, in accordance with one or more embodiments.

FIG. 2C shows a prediction for changes to an aspect of the operating ratio over time, in accordance with one or more embodiments.

FIG. 3 shows illustrative components for determining rightsizing adjustments to a cluster of cloud servers using a multi-dimensional operating ratio, in accordance with one or more embodiments.

FIG. 4 shows a flowchart of the steps involved in determining rightsizing adjustments to a cluster of cloud servers using a multi-dimensional operating ratio, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

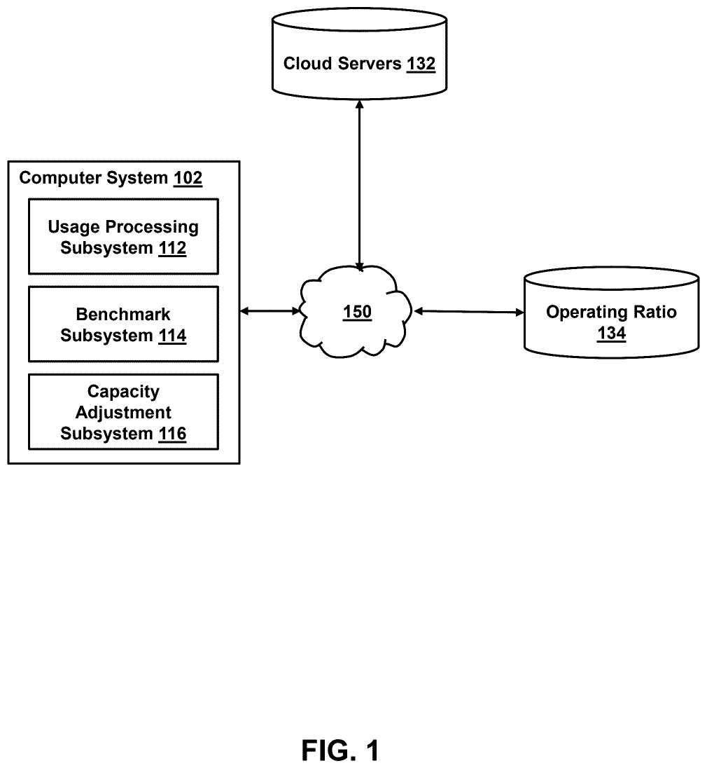

FIG. 1 shows an illustrative diagram for system 150, which contains hardware and software components used performing proactive workload management for a cluster of cloud servers, in accordance with one or more embodiments. For example, Computer System 102, a part of system 150, may include Usage Processing Subsystem 112, Benchmark Subsystem 114, and Capacity Adjustment Subsystem 116. System 150 may create, store, or otherwise interact with Cloud Servers 132 and Operating Ratio 134.

The system may be deployed to determine rightsizing adjustments to a cluster of cloud servers. The system may collect and process multiple dimensions of usage data to generate a multidimensional operating ratio. Using the multidimensional operating ratio, the system computes a workload metric indicating the distance from the cloud servers from its maximum capacity based on current and expected usage. Based on the workload metric, the system determines expected capacity needs of the cloud servers in anticipation of future usage. Based on the expected capacity needs, the system may determine appropriate modifications to the cloud servers to meet capacity needs.

The system may collect usage data from a cluster of cloud servers (e.g., Cloud Servers 132) that, for example, provide computing resources for training a machine learning model. Cloud servers may be virtual servers hosted and managed by cloud computing providers. Instead of being hosted on physical hardware like traditional servers, cloud servers run on virtualized environments that are part of a larger cloud infrastructure. Cloud servers can be created through virtualization technology, which allows multiple virtual servers to run on a single physical server. This enables efficient resource utilization and scalability. Cloud servers can be provisioned and deployed rapidly on demand. Additionally, cloud servers offer flexibility in terms of computing resources such as CPU, memory, storage, and network bandwidth. Users can allocate resources according to their needs and adjust them as required. Therefore, a cluster of cloud servers can be deployed across multiple physical servers and data centers, providing high availability and fault tolerance. Cloud servers enable horizontal scalability, allowing users to scale their applications by adding more instances of servers. This scalability ensures that applications can handle increased workload and traffic without performance degradation. Cloud servers may additionally offer vertical scalability, where the capacity of each server in a cluster of servers may be expanded when necessary.

The usage data may include multiple dimensions such as compute power usage, memory usage, I/O usage, network usage, and number of nodes of cloud computing clusters used. The system may aggregate such data from a plurality of usage instances, where each usage instance indicates an extent and type of usage and may be associated with a server in Cloud Servers 132. Based on the usage data, the system may determine a multidimensional operating ratio (Operating Ratio 134) for the cluster of cloud servers, wherein the multidimensional operating ratio is a vector of values comprising numerical representations for each dimension of usage in standardized units. For example, Operating Ratio 134 may record a number of CPU cycles, a number of gigabytes of memory used, an input/output count, a network bandwidth measurement, and a cloud computing node count for each usage instance. A usage instance may, for example, be a session of time during which the cloud server provides computational services to a client device. Usage instances may be associated with time stamps such as days, hours or seconds during which usage occurred. In some embodiments, the system may aggregate usage instances to form data for days, weeks, or quarters to provide an overview of usage. The system may perform data analysis on Operating Ratio 134 at various levels of granularity. For example, the system may process daily usage data as well as weekly or monthly data during its data cleansing process.

The system (e.g., Usage Processing Subsystem 112) processes Operating Ratio 134 using a cleansing process to generate processed usage data. For example, Usage Processing Subsystem 112 may perform outlier removal and seasonality adjustment, where the outlier removal identifies and removes volatile usage instances, and the seasonality adjustment modifies expected usage based on a time of year. Outlier removal is a process used in data analysis and statistics to identify and eliminate data points that significantly deviate from the rest of the dataset. Outliers are observations that lie far away from the majority of the data points and may distort statistical analyses, models, or visualizations if left unaddressed. Usage Processing Subsystem 112 may perform outlier removal to ensure that usage data accurately captures the typical operation of the cloud servers and is protected from irregularities such as spikes in any dimension of Operating Ratio 134. Usage Processing Subsystem 112 may identify potential outliers within the usage data by calculating statistical measures such as mean, median, standard deviation, or quartiles to find observations that fall significantly outside the expected range. The system may then detect outliers by, for example, identifying data points that fall beyond a certain number of standard deviations from the mean, or observations that fall below the first quartile or above the third quartile by a specified extent. The system may utilize algorithms such as isolation forests, k-means clustering, or density-based methods like DBSCAN to detect outliers.

In some embodiments, Usage Processing Subsystem 112 may simply remove the outliers from the dataset. Alternatively, the system may treat the data using methods like log transformation, square root transformation, or Box-Cox transformation to make the distribution more symmetrical and reduce the impact of outliers. The system may also replace outlier values with more plausible values based on interpolation, mean, median, or using predictive models to estimate missing values.

Prior to or concurrently as the system performs outlier removal, Usage Processing Subsystem 112 can apply seasonality adjustment to usage data. Seasonality adjustment, also known as seasonal adjustment, is a statistical technique used to remove the effects of seasonal patterns or fluctuations from time series data. Seasonality refers to regular and predictable patterns that occur in data at specific intervals, typically associated with recurring events such as seasons, holidays, or other calendar effects. The system may identify the seasonal patterns present in the data using statistical methods such as autocorrelation function (ACF) plots or seasonal decomposition techniques. Seasonal decomposition involves breaking down the time series data into its constituent components: trend, seasonality, and irregular or random fluctuations (often referred to as noise or residual). Once the seasonal component is identified, it can be removed or adjusted to isolate the underlying trend and irregular components. After seasonal adjustment, the trend and irregular components can be combined to reconstruct the seasonally adjusted time series.

The system (e.g., Benchmark Subsystem 114) may compare the processed usage data against a benchmark to generate a workload metric. The benchmark is a real-valued vector specifying expected usage data. The workload metric corresponds to each value in the multidimensional operating ratio and indicates a distance from the expected usage data. Benchmark Subsystem 114 may determine a benchmark based on extrapolation from historical usage data. For example, the system may fit a linear regression model on the processed usage data and perform time-series prediction to generate a vector of real values, each value in which corresponds to a dimension in Operating Ratio 134. The workload metric may be a mathematical distance from the benchmark, measured as a percentage of the benchmark. For example, if network bandwidth has a benchmark of 2 gigabytes but the average usage is 1.5 gigabytes, the workload metric may be 0.75. in some embodiments, the workload metric may be computed individually for each dimension of Operating Ratio 134, whereas in other embodiments the workload metric is averaged across all dimensions of Operating Ratio 134. In some embodiments, the system may use a machine learning model to determine the distance from the benchmark by performing time-series projection and/or distance-based clustering, for example.

Based on the workload metric and using a predictive model, the system generates expected capacity needs for the cluster of cloud servers. The expected capacity needs indicate cloud computing usage at a future point in time. The predictive model may be a changepoint detection model trained to perform time-series forecasting. Changepoint detection models are statistical techniques used to identify abrupt changes or shifts in time-series data. These models typically involve estimating parameters such as mean, variance, or distribution at different segments of the data and detecting points where these parameters significantly deviate from previous segments. Common approaches include Bayesian methods like the Bayesian Change Point Analysis (BCPA), which uses a prior distribution to update beliefs about the number and locations of changepoints, and frequentist methods like the Binary Segmentation algorithm, which iteratively splits the data into smaller segments and tests for significant changes using statistical criteria like the likelihood ratio test or Bayesian Information Criterion (BIC). In some embodiments, the predictive model may use techniques such as Hidden Markov Models (HMMs) and Sequential Monte Carlo methods to identify pattern changes in usage data and output expected capacity needs. The predictive model may output a numerical vector representing expected capacity needs, each value in the vector corresponding to a dimension in Operating Ratio 134. The predictive model may output expected capacity needs across the plurality of cloud servers based on historical usages and expected trends for each server. In addition, the predictive model may output undistributed expected usage, which is expected usage exceeding those attributed to each of the cloud servers. Based on the determined capacity needs, the predictive model may recommend one or more horizontal or vertical rightsizing changes. For example, for cloud servers that have capacity needs exceeding current specifications (e.g., due to a flood of incoming requested usage instances), the predictive model may estimate the amount of extra capacity required and recommend a vertical rightsizing change. Additionally or alternatively, the predictive model may determine that more servers are required in the cluster and recommend a horizontal rightsizing change.

Based on the expected capacity needs, the system (e.g., Capacity Adjustment Subsystem 116) determines a set of capacity adjustment changes. Based on the set of capacity adjustment changes, Capacity Adjustment Subsystem 116 adds new server components to the cluster of cloud servers and redistributes usage instances across the cluster of cloud servers. For example, Capacity Adjustment Subsystem 116 may devise changes to total workload capacity or workload distribution across the cluster of cloud servers. Capacity Adjustment Subsystem 116 may suggest horizontal and/or vertical changes to clusters. In addition, the system may suggest off-loading access requests to overloaded servers onto under-utilized servers to better balance workload. Capacity Adjustment Subsystem 116 may, for example, decide to increase the memory capacity of a cloud server based on expected capacity needs. Additionally, the system may route some requests to the cloud server to another server to manage workload distribution. Capacity Adjustment Subsystem 116 may decide to add another server to the server cluster to provide a margin of safety against unexpected increases in usage demands. The system may determine an extent of desired change based on expected capacity needs, such as a number of gigabytes in additional memory likely required by the cloud servers. The system may accordingly select a type of adjustment appropriate. For example, the system may commission a new cloud server to be added to the cluster for use by client devices. Alternatively, the system may decommission (spin out) server to drop from the cluster to decrease the cost and still providing adequate performance by using the rest cluster nodes. In some embodiments, the system may determine a method of change based on the required capacity expansions. For example, whereas the network bandwidth of a server can be adjusted with relative ease, the system may find it more difficult to increase a server's memory capacity. It may be especially difficult to make multiple adjustments to a cloud server, so Capacity Adjustment Subsystem 116 may handle such cases by finding a different cloud server that meets the capacity requirements. In some embodiments, the system may use a program with predetermined logic or a machine learning model to find the modification that meets capacity requirements at minimal cost.

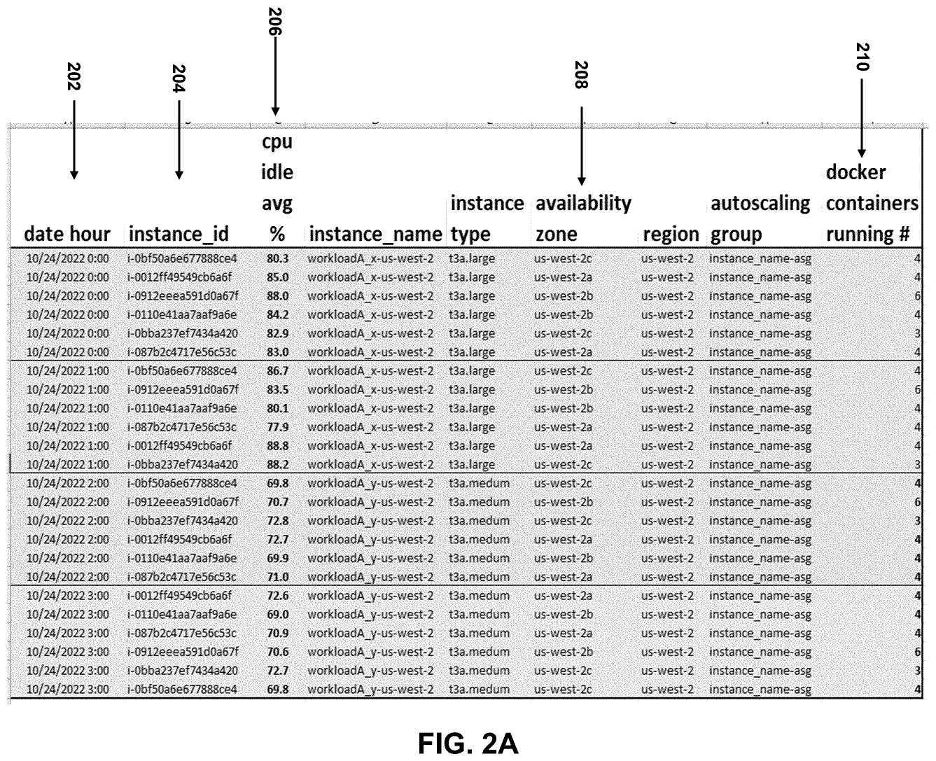

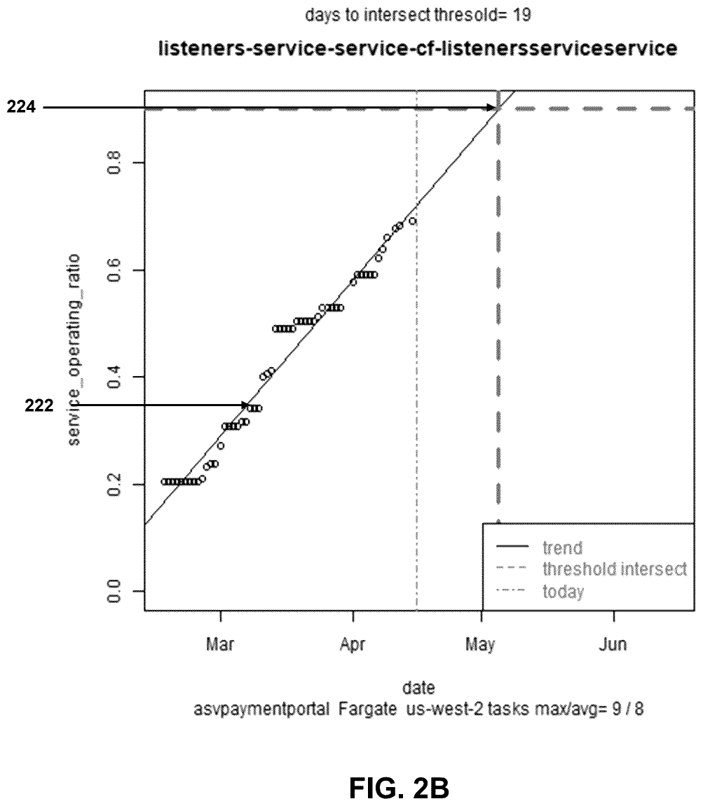

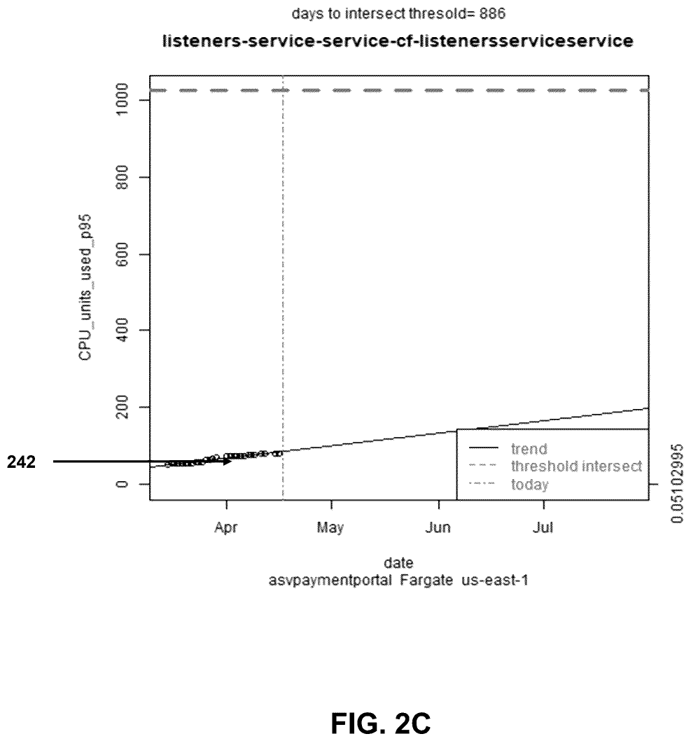

FIG. 2A shows unprocessed usage data collected from a cluster of cloud servers, of the same type as that used to determine operating ratios for cloud servers and estimate capacity needs. For example, the usage data may be collected from a plurality of cloud servers on a cluster and stored in a database for the system to access. The usage data may include a plurality of features or data attributes, consisting of quantitative or categorical values offering insight into each usage instance.

For example, Feature 202 of the usage data identifies an hour in which the cloud server usage occurred. This timestamp is helpful in identifying a date and time associated with cloud server usage, and may be used to perform seasonality adjustments in data cleansing. Additionally, the timestamp is a variable useful in changepoint detection. A time-series prediction model may take the time stamp as an input to establish a trend of changing cloud server usage. Additionally or alternatively, the model may use changepoint detection to identify changes to the trend to project future capacity needs for cloud servers.

Feature 204 may be an identifying string corresponding to a usage instance. The system may perform abnormality detection based on other attributes of cloud usage instances and remove instances found to be outliers. The instance ID, such as Feature 204, may be used for this purpose.

Feature 206 describes a usage extent associated with the cloud usage instance. In particular, it describes a quantitative measure for the CPU idle percentage averaged across the usage instance. This offers the system a metric for how close the cloud server is operating to capacity. In other datasets, there may be quantitative measures of other dimensions of usage, such as memory usage and network bandwidth usage. The system may correlate these dimensions using the instance identifier string of Feature 204, for example. The system may create a vector of real values to form a multidimensional operating ratio for each usage instance. Feature 210 is another usage dimension, describing the number of docker containers running.

Feature 208 identifies a server cluster to which the usage instance is assigned. In some embodiments, a server cluster may share some functionality such that servers within the cluster may offload some tasks onto one another when inundated with requests. The system may take cluster location into account when determining rightsizing changes to a server. For example, in an underutilized cluster, the system may be more inclined to redistribute the task to a different server instead of expanding the capacity of the cluster.

FIG. 2B shows a prediction for an aspect of the operating ratio hitting a threshold, in accordance with one or more embodiments. For example, the system may project a trend of operating ratio based on historical data. By aggregating operating ratio data up to the present, the system may fit a model such as a linear regression or multivariate regression model to project a trend such as Trend 222. Trend 222 indicates an expectation that the operating ratio will continue to increase. The system may project that if Trend 222 continues, the operating ratio will hit a predetermined threshold at Date 224. At that point, the system may need to increase the capacity of the cloud server cluster or reduce services provided.

FIG. 2C shows a prediction for changes to an aspect of the operating ratio over time. Similar to Trend 222 in FIG. 2B, the system may project a trend of operating ratio based on historical data. In this case, Trend 242 concerns CPU usage, a dimension of the operating ratio. Trend 242 indicates that while CPU usage is increasing, it remains well below the threshold to cause the cloud server cluster to need more CPU capacity. In fact, Trend 242 would indicate that this cloud server cluster is under-utilized with respect to CPU capacity, and the system may reroute some tasks to achieve fuller utilization.

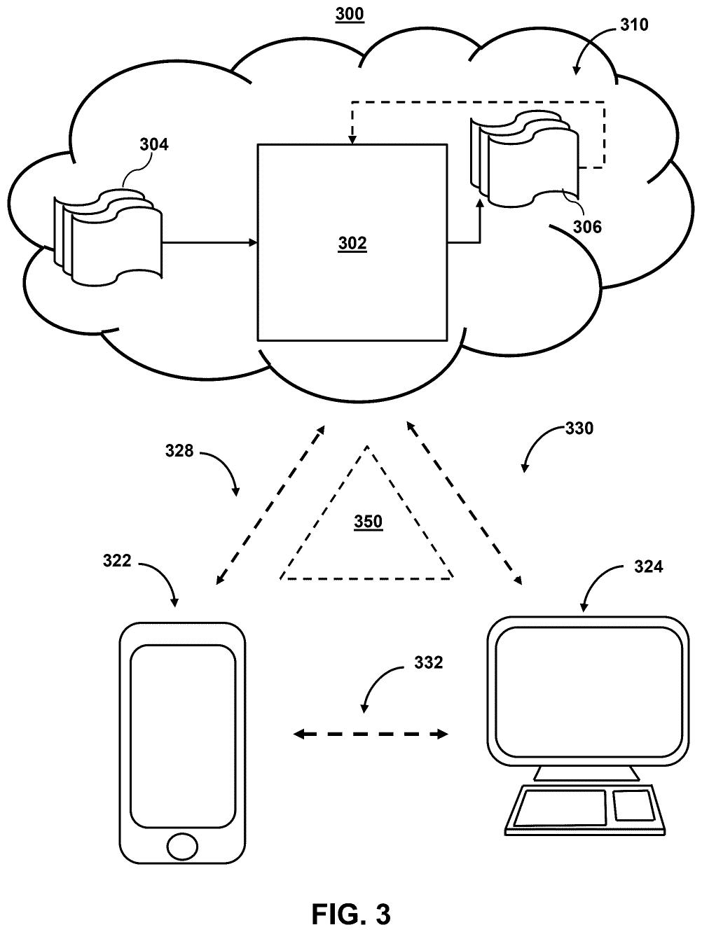

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions (e.g., change points corresponding to shifts in the pattern of cloud capacity usage).

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., whether a change point in time-series operating ratio data indicates a rise in expected capacity needs).

In some embodiments, the model (e.g., model 302) may automatically perform actions based on outputs 306. In some embodiments, the model (e.g., model 302) may not perform any actions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDOS protection, and API layer 350 may use RESTful APIs as standard for external integration.

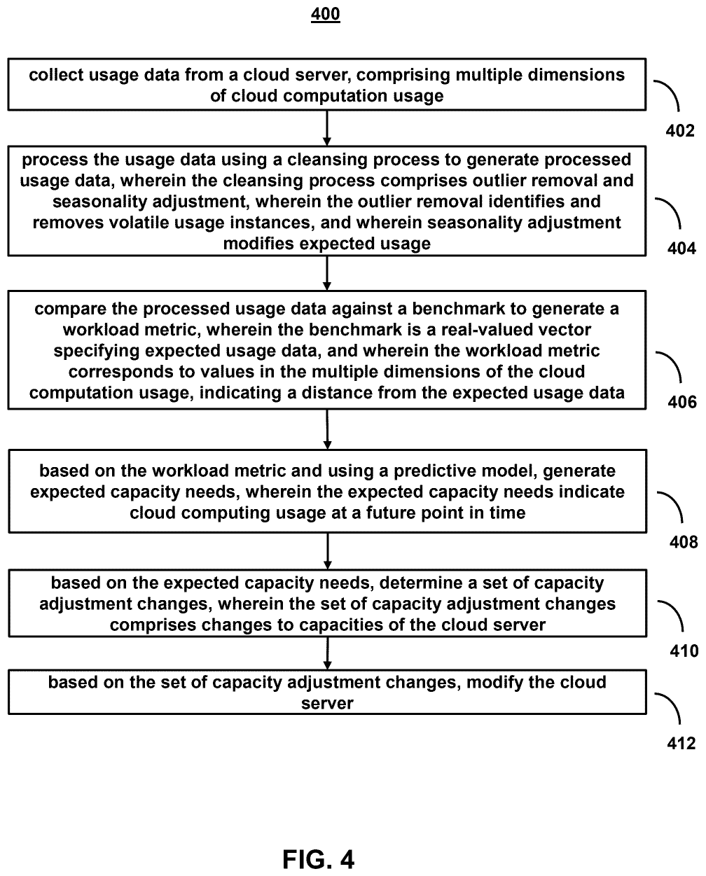

FIG. 4 shows a flowchart of the steps involved in determining rightsizing adjustments to a cluster of cloud servers using a multi-dimensional operating ratio, in accordance with one or more embodiments. For example, the system may use process 400 (e.g., as implemented on one or more system components described above) in order to collect and process multiple dimensions of usage data to generate a multidimensional operating ratio, compute a workload metric, determine expected capacity needs of the cloud servers in anticipation of future usage, and find appropriate modifications to the cloud servers to meet capacity needs.

At step 402, process 400 (e.g., using one or more components described above) collects usage data from a cloud server, comprising multiple dimensions of cloud computation usage. The system may collect usage data from a cluster of cloud servers (e.g., Cloud Servers 132) that, for example, provide computing resources for training a machine learning model. Cloud servers may be virtual servers hosted and managed by cloud computing providers. Instead of being hosted on physical hardware like traditional servers, cloud servers run on virtualized environments that are part of a larger cloud infrastructure. Cloud servers can be created through virtualization technology, which allows multiple virtual servers to run on a single physical server. This enables efficient resource utilization and scalability. Cloud servers can be provisioned and deployed rapidly on demand. Additionally, cloud servers offer flexibility in terms of computing resources such as CPU, memory, storage, and network bandwidth. Users can allocate resources according to their needs and adjust them as required. Therefore, a cluster of cloud servers can be deployed across multiple physical servers and data centers, providing high availability and fault tolerance. Cloud servers enable horizontal scalability, allowing users to scale their applications by adding more instances of servers. This scalability ensures that applications can handle increased workload and traffic without performance degradation. Cloud servers may additionally offer vertical scalability, where the capacity of each server in a cluster of servers may be expanded when necessary.

The usage data may include multiple dimensions such as compute power usage, memory usage, I/O usage, network usage, and number of nodes of cloud computing clusters used. The system may aggregate such data from a plurality of usage instances, where each usage instance indicates an extent and type of usage and may be associated with a server in Cloud Servers 132. Based on the usage data, the system may determine a multidimensional operating ratio (Operating Ratio 134) for the cluster of cloud servers, wherein the multidimensional operating ratio is a vector of values comprising numerical representations for each dimension of usage in standardized units. For example, Operating Ratio 134 may record a number of CPU cycles, a number of gigabytes of memory used, an input/output count, a network bandwidth measurement, and a cloud computing node count for each usage instance. A usage instance may, for example, be a session of time during which the cloud server provides computational services to a client device. Usage instances may be associated with time stamps such as days, hours or seconds during which usage occurred. In some embodiments, the system may aggregate usage instances to form data for days, weeks, or quarters to provide an overview of usage. The system may perform data analysis on Operating Ratio 134 at various levels of granularity. For example, the system may process daily usage data as well as weekly or monthly data during its data cleansing process.

At step 404, process 400 (e.g., using one or more components described above) processes the usage data using a cleansing process to generate processed usage data. The cleansing process comprises outlier removal and seasonality adjustment: outlier removal identifies and removes volatile usage instances, whereas seasonality adjustment modifies expected usage. The system (e.g., Usage Processing Subsystem 112) processes Operating Ratio 134 using a cleansing process to generate processed usage data. For example, Usage Processing Subsystem 112 may perform outlier removal and seasonality adjustment, where the outlier removal identifies and removes volatile usage instances, and the seasonality adjustment modifies expected usage based on a time of year. Outlier removal is a process used in data analysis and statistics to identify and eliminate data points that significantly deviate from the rest of the dataset. Outliers are observations that lie far away from the majority of the data points and may distort statistical analyses, models, or visualizations if left unaddressed. Usage Processing Subsystem 112 may perform outlier removal to ensure that usage data accurately captures the typical operation of the cloud servers and is protected from irregularities such as spikes in any dimension of Operating Ratio 134. Usage Processing Subsystem 112 may identify potential outliers within the usage data by calculating statistical measures such as mean, median, standard deviation, or quartiles to find observations that fall significantly outside the expected range. The system may then detect outliers by, for example, identifying data points that fall beyond a certain number of standard deviations from the mean, or observations that fall below the first quartile or above the third quartile by a specified extent. The system may utilize algorithms such as isolation forests, k-means clustering, or density-based methods like DBSCAN to detect outliers.

In some embodiments, Usage Processing Subsystem 112 may simply remove the outliers from the dataset. Alternatively, the system may treat the data using methods like log transformation, square root transformation, or Box-Cox transformation to make the distribution more symmetrical and reduce the impact of outliers. The system may also replace outlier values with more plausible values based on interpolation, mean, median, or using predictive models to estimate missing values.

Prior to or concurrently as the system performs outlier removal, Usage Processing Subsystem 112 can apply seasonality adjustment to usage data. Seasonality adjustment, also known as seasonal adjustment, is a statistical technique used to remove the effects of seasonal patterns or fluctuations from time series data. Seasonality refers to regular and predictable patterns that occur in data at specific intervals, typically associated with recurring events such as seasons, holidays, or other calendar effects. The system may identify the seasonal patterns present in the data using statistical methods such as autocorrelation function (ACF) plots or seasonal decomposition techniques. Seasonal decomposition involves breaking down the time series data into its constituent components: trend, seasonality, and irregular or random fluctuations (often referred to as noise or residual). Once the seasonal component is identified, it can be removed or adjusted to isolate the underlying trend and irregular components. After seasonal adjustment, the trend and irregular components can be combined to reconstruct the seasonally adjusted time series.

At step 406, process 400 (e.g., using one or more components described above) compares the processed usage data against a benchmark to generate a workload metric. The benchmark is a real-valued vector specifying expected usage data, and wherein the workload metric corresponds to values in the multiple dimensions of the cloud computation usage, indicating a distance from the expected usage data. The system (e.g., Benchmark Subsystem 114) may compare the processed usage data against a benchmark to generate a workload metric. The benchmark is a real-valued vector specifying expected usage data. The workload metric corresponds to each value in the multidimensional operating ratio and indicates a distance from the expected usage data. Benchmark Subsystem 114 may determine a benchmark based on extrapolation from historical usage data. For example, the system may fit a linear regression model on the processed usage data and perform time-series prediction to generate a vector of real values, each value in which corresponds to a dimension in Operating Ratio 134. The workload metric may be a mathematical distance from the benchmark, measured as a percentage of the benchmark. For example, if network bandwidth has a benchmark of 2 gigabytes but the average usage is 1.5 gigabytes, the workload metric may be 0.75. in some embodiments, the workload metric may be computed individually for each dimension of Operating Ratio 134, whereas in other embodiments the workload metric is averaged across all dimensions of Operating Ratio 134. In some embodiments, the system may use a machine learning model to determine the distance from the benchmark by performing time-series projection and/or distance-based clustering, for example.

At step 408, process 400 (e.g., using one or more components described above) generates expected capacity needs based on the workload metric and using a predictive model. The expected capacity needs indicate cloud computing usage at a future point in time. Based on the workload metric and using a predictive model, the system generates expected capacity needs for the cluster of cloud servers. The expected capacity needs indicate cloud computing usage at a future point in time. The predictive model may be a changepoint detection model trained to perform time-series forecasting. Changepoint detection models are statistical techniques used to identify abrupt changes or shifts in time-series data. These models typically involve estimating parameters such as mean, variance, or distribution at different segments of the data and detecting points where these parameters significantly deviate from previous segments. Common approaches include Bayesian methods like the Bayesian Change Point Analysis (BCPA), which uses a prior distribution to update beliefs about the number and locations of changepoints, and frequentist methods like the Binary Segmentation algorithm, which iteratively splits the data into smaller segments and tests for significant changes using statistical criteria like the likelihood ratio test or Bayesian Information Criterion (BIC). In some embodiments, the predictive model may use techniques such as Hidden Markov Models (HMMs) and Sequential Monte Carlo methods to identify pattern changes in usage data and output expected capacity needs. The predictive model may output a numerical vector representing expected capacity needs, each value in the vector corresponding to a dimension in Operating Ratio 134. The predictive model may output expected capacity needs across the plurality of cloud servers based on historical usages and expected trends for each server. In addition, the predictive model may output undistributed expected usage, which is expected usage exceeding those attributed to each of the cloud servers. Based on the determined capacity needs, the predictive model may recommend one or more horizontal or vertical rightsizing changes. For example, for cloud servers that have capacity needs exceeding current specifications (e.g., due to a flood of incoming requested usage instances), the predictive model may estimate the amount of extra capacity required and recommend a vertical rightsizing change. Additionally or alternatively, the predictive model may determine that more servers are required in the cluster and recommend a horizontal rightsizing change.

At step 410, process 400 (e.g., using one or more components described above) determines a set of capacity adjustment changes. The set of capacity adjustment changes comprises changes to capacities of the cloud server based on the expected capacity needs. Based on the expected capacity needs, the system (e.g., Capacity Adjustment Subsystem 116) determines a set of capacity adjustment changes. Based on the set of capacity adjustment changes, Capacity Adjustment Subsystem 116 adds new server components to the cluster of cloud servers and redistributes usage instances across the cluster of cloud servers. For example, Capacity Adjustment Subsystem 116 may devise changes to total workload capacity or workload distribution across the cluster of cloud servers. Capacity Adjustment Subsystem 116 may suggest horizontal and/or vertical changes to clusters. In addition, the system may suggest off-loading access requests to overloaded servers onto under-utilized servers to better balance workload. Capacity Adjustment Subsystem 116 may, for example, decide to increase the memory capacity of a cloud server based on expected capacity needs. Additionally, the system may route some requests to the cloud server to another server to manage workload distribution. Capacity Adjustment Subsystem 116 may decide to add another server to the server cluster to provide a margin of safety against unexpected increases in usage demands. The system may determine an extent of desired change based on expected capacity needs, such as a number of gigabytes in additional memory likely required by the cloud servers. The system may accordingly select a type of adjustment appropriate.

At step 412, process 400 (e.g., using one or more components described above) modifies the cloud server based on the set of capacity adjustment changes. For example, the system may commission a new cloud server to be added to the cluster for use by client devices. Alternatively, the system may. In some embodiments, the system may determine a method of change based on the required capacity expansions. For example, whereas the network bandwidth of a server can be adjusted with relative ease, the system may find it more difficult to increase a server's memory capacity. It may be especially difficult to make multiple adjustments to a cloud server, so Capacity Adjustment Subsystem 116 may handle such cases by finding a different cloud server that meets the capacity requirements. In some embodiments, the system may use a program with predetermined logic or a machine learning model to find the modification that meets capacity requirements at minimal cost.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. (For example, the serverless container clusters may have 2-dimensional operating ratio to describe how workload/service uses capacity (CPU and memory usage) plus number of tasks running simultaneously to provide horizontal scalability.)

The present techniques will be better understood with reference to the following enumerated embodiments:

1. A method for performing proactive workload management for a cluster of cloud servers, the system comprising: collecting usage data from a cluster of cloud servers, comprising server logs for a plurality of cloud server usage instances in a first period of time; based on the usage data, determining a multidimensional operating ratio for the cluster of cloud servers, wherein the multidimensional operating ratio is a vector of values comprising a compute power usage, a memory usage, an I/O usage, a network usage, and a number of nodes of cloud computing clusters used; processing the multidimensional operating ratio using a cleansing process to generate processed usage data, wherein the cleansing process comprises outlier removal and seasonality adjustment, wherein outlier removal identifies and removes volatile usage instances, and wherein the seasonality adjustment modifies expected usage based on a time of year; comparing the processed usage data against a benchmark to generate a workload metric, wherein the benchmark is a real-valued vector specifying expected usage data, and wherein the workload metric corresponds to each value in the multidimensional operating ratio and indicates a distance from the expected usage data; based on the workload metric and using a predictive model, generating expected capacity needs for the cluster of cloud servers, wherein the expected capacity needs indicate cloud computing usage at a future point in time, and wherein the predictive model is a changepoint detection model trained to perform time-series forecasting; based on the expected capacity needs, determining a set of capacity adjustment changes, wherein the set of capacity adjustment changes comprises changes to total workload capacity or workload distribution across the cluster of cloud servers; and based on the set of capacity adjustment changes, adding new server components to the cluster of cloud servers and redistributing usage instances across the cluster of cloud servers.
2. A method for performing proactive workload management for a cluster of cloud servers, comprising: collecting usage data from a cloud server, comprising multiple dimensions of cloud computation usage; processing the usage data using a cleansing process to generate processed usage data, wherein the cleansing process comprises outlier removal and seasonality adjustment, wherein outlier removal identifies and removes volatile usage instances, and wherein seasonality adjustment modifies expected usage; comparing the processed usage data against a benchmark to generate a workload metric, wherein the benchmark is a real-valued vector specifying expected usage data, and wherein the workload metric corresponds to values in the multiple dimensions of the cloud computation usage, indicating a distance from the expected usage data; based on the workload metric and using a predictive model, generating expected capacity needs, wherein the expected capacity needs indicate cloud computing usage at a future point in time; based on the expected capacity needs, determining a set of rightsizing changes, wherein the set of rightsizing changes comprises changes to capacities of the cloud server; and based on the set of rightsizing changes, modifying the cloud server.
3. A method comprising: collecting usage data from a cloud server, comprising multiple dimensions of cloud computation usage; processing the usage data using a cleansing process to generate processed usage data; comparing the processed usage data against a benchmark to generate a workload metric; based on the workload metric, generating expected capacity needs, wherein the expected capacity needs indicate cloud computing usage at a future point in time; based on the expected capacity needs, determining a set of rightsizing changes, wherein the set of rightsizing changes comprises changes to the cloud server; and based on the set of rightsizing changes, modifying the cloud server.
4. The method of any one of the preceding embodiments, wherein generating a workload metric comprises: using a mathematical combination of usage data, calculate a multidimensional operating ratio, comprising a maximum of numerical estimates for a compute power usage, a memory usage, I/O usage, a network usage, and a number of nodes of cloud computing clusters used.
5. The method of any one of the preceding embodiments, further comprising: computing a workload metric based on the multidimensional operating ratio, comprising weighted distances of the compute power usage, the memory usage, the I/O usage, the network usage, and the number of nodes of cloud computing clusters used from their respective benchmarks.
6. The method of any one of the preceding embodiments, wherein processing the usage data using a cleansing process further comprises: standardizing formatting and units of measurement for the usage data; using an anomaly detection algorithm, identifying a plurality of outliers in the usage data; and generating the processed usage data by removing the plurality of outliers from the usage data.
7. The method of any one of the preceding embodiments, wherein comparing the processed usage data against a benchmark further comprises: generating a benchmark, wherein the benchmark comprises numerical estimates for usage data based on historical usage data; generating, in association with the benchmark, a margin of error indicating a degree of expected random variation; and comparing a numeric difference between the processed usage data and the benchmark against the margin of error.
8. The method of any one of the preceding embodiments, wherein based on the expected capacity needs, determining a set of rightsizing changes comprises: determining a time of change based on the expected capacity needs; determining an extent of change based on the expected capacity needs; and determining a method of change based on the workload metric.
9. The method of any one of the preceding embodiments, wherein determining the method of change comprises: determining to add server components to the cloud server; determining changes to sizes of each server component within the cloud server; and redistributing computational tasks of the cloud server among server components.
10. The method of any one of the preceding embodiments, wherein determining changes to sizes of each server component within the cloud server comprises determining costs of incremental adjustments to server components.
11. The method of any one of the preceding embodiments, wherein generating expected capacity needs comprises: generating the predictive model to capture a relationship between usage data and values corresponding to the multidimensional operating ratio, wherein the predictive model is a multivariate linear model trained on historical usage data; and using the multivariate linear model, generating projected usage data based on the workload metric.
12. The method of any one of the preceding embodiments, further comprising: adjusting the benchmark based on seasonal fluctuations of usage of the cloud server; and based on the adjusted benchmark, generating a second workload metric.
13. One or more non-transitory, computer-readable media storing instructions that, when executed by a data processing apparatus, cause the data processing apparatus to perform operations comprising those of any of embodiments 1-12.
14. A system comprising one or more processors; and memory storing instructions that, when executed by the processors, cause the processors to effectuate operations comprising those of any of embodiments 1-12.
15. A system comprising means for performing any of embodiments 1-12.

What is claimed is:

1. A system for performing proactive workload management for a cluster of cloud servers, the system comprising:
one or more processors; and
one or more non-transitory, computer-readable media comprising instructions that, when executed by the one or more processors, cause operations comprising:
collecting usage data from a cluster of cloud servers, comprising server logs for a plurality of cloud server usage instances in a first period of time;
based on the usage data, determining a multidimensional operating ratio for the cluster of cloud servers, wherein the multidimensional operating ratio is a vector of values comprising a compute power usage, a memory usage, an I/O usage, a network usage, and a number of nodes of cloud computing clusters used;
processing the multidimensional operating ratio using a cleansing process to generate processed usage data, wherein the cleansing process comprises outlier removal and seasonality adjustment, wherein outlier removal identifies and removes volatile usage instances, and wherein the seasonality adjustment modifies expected usage based on a time of year;
comparing the processed usage data against a benchmark to generate a workload metric, wherein the benchmark is a real-valued vector specifying expected usage data, and wherein the workload metric corresponds to each value in the multidimensional operating ratio and indicates a distance from the expected usage data;
based on the workload metric and using a predictive model, generating expected capacity needs for the cluster of cloud servers, wherein the expected capacity needs indicate cloud computing usage at a future point in time, and wherein the predictive model is a changepoint detection model trained to perform time-series forecasting;
based on the expected capacity needs, determining a set of capacity adjustment changes, wherein the set of capacity adjustment changes comprises changes to total workload capacity or workload distribution across the cluster of cloud servers; and
based on the set of capacity adjustment changes, adding new server components to the cluster of cloud servers and redistributing usage instances across the cluster of cloud servers.

2. A method for performing proactive workload management for a cluster of cloud servers, comprising:
collecting usage data from a cloud server, comprising multiple dimensions of cloud computation usage;
processing the usage data using a cleansing process to generate processed usage data, wherein the cleansing process comprises outlier removal and seasonality adjustment, wherein outlier removal identifies and removes volatile usage instances, and wherein seasonality adjustment modifies expected usage;
comparing the processed usage data against a benchmark to generate a workload metric, wherein the benchmark is a real-valued vector specifying expected usage data, and wherein the workload metric corresponds to values in the multiple dimensions of the cloud computation usage, indicating a distance from the expected usage data;
based on the workload metric and using a predictive model, generating expected capacity needs, wherein the expected capacity needs indicate cloud computing usage at a future point in time;
based on the expected capacity needs, determining a set of capacity adjustment changes, wherein the set of capacity adjustment changes comprises changes to capacities of the cloud server; and
based on the set of capacity adjustment changes, modifying the cloud server.

3. The method of claim 2, wherein generating a workload metric comprises:
using a mathematical combination of usage data, calculate a multidimensional operating ratio, comprising a maximum of numerical estimates for a compute power usage, a memory usage, I/O usage, a network usage, and a number of nodes of cloud computing clusters used.

4. The method of claim 3, further comprising:
computing a workload metric based on the multidimensional operating ratio, comprising weighted distances of the compute power usage, the memory usage, the I/O usage, the network usage, and the number of nodes of cloud computing clusters used from their respective benchmarks.

5. The method of claim 2, further comprising:
adjusting the benchmark based on seasonal fluctuations of usage of the cloud server; and
based on the adjusted benchmark, generating a second workload metric.

6. The method of claim 2, wherein processing the usage data using a cleansing process further comprises:
standardizing formatting and units of measurement for the usage data;
using an anomaly detection algorithm, identifying a plurality of outliers in the usage data; and
generating the processed usage data by removing the plurality of outliers from the usage data.

7. The method of claim 2, wherein comparing the processed usage data against a benchmark further comprises:
generating a benchmark, wherein the benchmark comprises numerical estimates for usage data based on historical usage data;
generating, in association with the benchmark, a margin of error indicating a degree of expected random variation; and
comparing a numeric difference between the processed usage data and the benchmark against the margin of error.

8. The method of claim 2, wherein based on the expected capacity needs, determining a set of capacity adjustment changes comprises:
determining a time of change based on the expected capacity needs;
determining an extent of change based on the expected capacity needs; and
determining a method of change based on the workload metric.

9. The method of claim 8, wherein determining the method of change comprises:
determining to add server components to the cloud server;
determining changes to sizes of each server component within the cloud server; and
redistributing computational tasks of the cloud server among server components.

10. The method of claim 9, wherein determining changes to sizes of each server component within the cloud server comprises determining costs of incremental adjustments to server components.

11. The method of claim 3, wherein generating expected capacity needs comprises:
generating the predictive model to capture a relationship between usage data and values corresponding to the multidimensional operating ratio, wherein the predictive model is a multivariate linear model trained on historical usage data; and
using the multivariate linear model, generating projected usage data based on the workload metric.

12. One or more non-transitory computer-readable media comprising instructions that, when executed by one or more processors, cause operations comprising:
collecting usage data from a cloud server, comprising multiple dimensions of cloud computation usage;
processing the usage data using a cleansing process to generate processed usage data;
comparing the processed usage data against a benchmark to generate a workload metric;
based on the workload metric, generating expected capacity needs, wherein the expected capacity needs indicate cloud computing usage at a future point in time;
based on the expected capacity needs, determining a set of capacity adjustment changes, wherein the set of capacity adjustment changes comprises changes to the cloud server; and
based on the set of capacity adjustment changes, modifying the cloud server.

13. The one or more non-transitory computer-readable media of claim 12, wherein generating a workload metric comprises:
using a mathematical combination of usage data, calculate a multidimensional operating ratio, comprising a maximum of numerical estimates for a compute power usage, a memory usage, an I/O usage, a network usage, and a number of nodes of cloud computing clusters used.

14. The one or more non-transitory computer-readable media of claim 13, wherein generating expected capacity needs comprises:
generating a predictive model to capture a relationship between usage data and values corresponding to the multidimensional operating ratio, wherein the predictive model is a multivariate linear model trained on historical usage data; and
using the multivariate linear model, generating projected usage data based on the workload metric.

15. The one or more non-transitory computer-readable media of claim 12, wherein the operations further comprise:
adjusting the benchmark based on seasonal fluctuations of usage of the cloud server; and
based on the adjusted benchmark, generating a second workload metric.

16. The one or more non-transitory computer-readable media of claim 12, wherein processing the usage data using a cleansing process further comprises:
standardizing formatting and units of measurement for the usage data;
using an anomaly detection algorithm, identifying a plurality of outliers in the usage data; and
generating the processed usage data by removing the plurality of outliers from the usage data.

17. The one or more non-transitory computer-readable media of claim 12, wherein comparing the processed usage data against a benchmark further comprises:
generating a benchmark, wherein the benchmark comprises numerical estimates for usage data based on historical usage data;
generating, in association with the benchmark, a margin of error indicating a degree of expected random variation; and
comparing a numeric difference between the processed usage data and the benchmark against the margin of error.

18. The one or more non-transitory computer-readable media of claim 12, wherein based on the expected capacity needs, determining a set of capacity adjustment changes comprises:
determining a time of change based on the expected capacity needs;
determining an extent of change based on the expected capacity needs; and
determining a method of change based on the workload metric.

19. The one or more non-transitory computer-readable media of claim 18, wherein determining the method of change comprises:
determining to add server components to the cloud server;
determining changes to sizes of each server component within the cloud server; and
redistributing computational tasks of the cloud server among server components.

20. The one or more non-transitory computer-readable media of claim 19, wherein determining changes to sizes of each server component within the cloud server comprises determining costs of incremental adjustments to server components.
